(19) United States
(12) Patent Application Publication
(10) Pub. No.: US 2009/0202678 A1
(43) Pub. Date: Aug. 13, 2009

(54) Probiotic Microorganism Compositions Granules Containing Them, Method for the Preparation Thereof and Uses Thereof

(75) Inventors: Cecile Sampsonis, Lille (FR); Eric Auclair, Avelin (FR)

Correspondence Address: MCANDREWS HELD & MALLOY, LTD, 500 WEST MADISON STREET, SUITE 3400, CHICAGO, IL, 60661, US

(73) Assignee: LESAFFRE ET COMPAGNIE, Paris (FR)

(21) Appl. No.: 12/301,501

(22) PCT Filed: May 16, 2007
(86) PCT No.: PCT/FR2007/000835

§ 371 Date: Nov. 19, 2008

(30) Foreign Application Priority Data
May 19, 2006 (FR) 0604527

(51) Int. Cl. A23K 1/00; A23L 1/28

(52) U.S. Cl. 426/60; 426/62

(57) ABSTRACT

The present invention relates to a probiotic composition or premix comprising live or regeneratable probiotic microorganisms, yeast walls and/or deactivated yeasts, and, optionally a nutritional supplement comprising in particular vitamins and/or trace elements and/or amino acids and/or other additives intended for animal nutrition. It also relates to granules comprising said composition and intended for animal nutrition, and also to a method for preparing said granules.

The present application is filed pursuant to 35 U.S.C. 371 as a U.S. National Phase application of International Patent Application No. PCT/FR07/00835, which was filed May 16, 2007, claiming the benefit of priority to French Patent Application No. FR 0604527, which was filed on May 19, 2006. The entire text of the aforementioned applications is incorporated herein by reference in its entirety.

The subject of the present invention is a probiotic composition or premix comprising live or regeneratable probiotic microorganisms and yeast walls and/or deactivated yeasts, the presence of the yeast walls and/or deactivated yeasts allowing in particular the stabilization of the probiotic microorganisms. This composition or premix may be used for the preparation of granules which will be intended as animal feed.

The term “probiotics” denotes live microorganisms which, when they are consumed in a sufficient quantity, exert a positive effect on the host organism by improving the properties of its intestinal flora beyond the traditional nutritional effects. They constitute an alternative to the use of antibiotics in animal feed.) They are most often bacteria or yeasts present either in foods or in food supplements.

There are four main types of probiotics:
lactic acid bacteria (lactobacilli and the cocci),
bifidobacteria of human or animal origin,
various yeasts, including yeasts of the Saccharomyces type,
other spore-forming bacteria, including Bacillus subtillis and cereus.

Microorganisms killed by heat do not correspond to the definition of probiotics even though it has been possible to attribute some therapeutic effects to them.

In the wider sense, the term “probiotics” also denotes foods containing such microorganisms.

Probiotics are increasingly used both for human consumption and as animal feed, in particular as a substitute for antibiotics given in particular a return to a healthier, more natural and more environmentally friendly diet. In animal nutrition, these microorganisms are generally added to a granulated feed via a premix also containing vitamins, trace elements and amino acids.

The introduction of probiotic microorganisms into granules is however not easy; indeed, probiotic microorganisms are most often destroyed during the granulation process. This step in the manufacture of the granules is performed in the presence of steam at temperatures of between 60° C. and 100° C. and at pressures ranging from 0.5 to 3.5 bar; temperature and moisture conditions in which the microorganisms are generally destroyed.

In patent application EP 0 694 610, the resistance to granulation of yeasts of the species Phaffia rhodozyma which produce a colorant, astaxanthin, and are used in fish feed to give the red color to farmed trout and salmon, has been improved by drying in the presence of a sugar such as glucose.

However, this case did not involve probiotic yeasts which must remain alive up to their ingestion by animals in order to fulfill their functions.

Surprisingly and unexpectedly, the inventors have found that probiotic microorganisms could exhibit increased stability in premixes over time by mixing with yeast walls and/or deactivated yeasts in place of other traditionally used carriers for premixes such as wheat meal or calcium carbonate. This improved stability over time then makes them more resistant to granulation.

The use of yeast walls in the pharmacology and agrifoodstuffs sector has already been described. These walls are used as excipient in the manufacture of pharmaceutical tablets, in particular as binding agent with disintegrating properties (Ozeki et al. AAPS PharmSciTech, 2003; 4(3):E41) or as coating product component (EP 1 159 882, Yuasa et al. Int J. Pharm., 2002, Apr. 26; 237 (1-2): 15-22). To the knowledge of the applicant company, the possibility of using them to improve the stability of live or regeneratable microorganisms has however never been envisaged up until now.

A real need therefore exists for probiotic microorganisms which are stable over time such that the expected effect on the health of the animal ingesting them is real.

The subject of the invention is therefore a probiotic composition or premix comprising:
from 0.5 to 75% of live or regeneratable probiotic microorganisms (a) chosen from the group comprising probiotic yeasts, probiotic bacteria of the type comprising lactic acid bacteria chosen from lactobacilli, and bifidobacteria with the exception of bacilli, and mixtures thereof,
from 10 to 95% of a compound (b) chosen from yeast walls and deactivated yeasts, and
from 0 to 95% of a nutritional supplement (c) comprising in particular vitamins, and/or trace elements, and/or amino acids, and/or other additives intended for animal feed,
   the percentages being expressed as dry weight relative to the total weight of the composition.

In the present invention, the expression “regeneratable” or “viable” microorganisms is understood to mean microorganisms which, in the presence of a nutrient medium, recover their capacity to divide and form colonies.

By way of example of probiotic yeast, there may be mentioned the probiotic yeasts chosen from the group comprising the yeasts of the genus Saccharomyces, preferably of the species Saccharomyces cerevisiae, or of the genus Kluyveromyces such as Kluyveromyces marxianus and mixtures thereof.

Preferred examples of Saccharomyces cerevisiae strains are the Saccharomyces cerevisiae Sc47 strain deposited at the NCYC under the number 47, the Saccharomyces cerevisiae strain deposited at the Pasteur collection (CNCM) under the number I-1077, the Saccharomyces cerevisiae strain deposited at the Pasteur collection (CNCM) under the number I-1079, the Saccharomyces cerevisiae strain deposited at the MUCL collection under the number 39 885, the Saccharomyces cerevisiae strain deposited at the CBS collection under the number 39 493.94, the Kluyveromyces marxianus strain deposited at the MUCL collection under the number 39434, and mixtures thereof.

Most preferably, the composition according to the present invention comprises yeasts corresponding to the Saccharomyces cerevisiae Sc47 strain deposited at the NCYC under the number 47.

Thus, according to a most particular embodiment, said probiotic composition or premix comprises:
from 0.5 to 75%, preferably 5 to 30% of live or regeneratable yeasts,
from 10 to 80%, preferably 25 to 50% of yeast walls and/or deactivated yeasts,
from 0 to 95%, preferably 5 to 80% of nutritional supplement,
   the percentages being expressed as dry weight relative to the total weight of the composition.

This composition is particularly suitable as monogastric animal feed.

The yeast walls, for their part, may be chosen from all sorts of food grade yeasts, for example Saccharomyces cerevisiae. More particularly, the yeast walls are obtained from yeasts marketed under the trade marks PRONARDY®, SAFMANNAN® or BIOMOS® by the companies Prodessa, Biospringer and Alltech, respectively.

The yeast walls may be obtained according to methods known to persons skilled in the art; there may be mentioned more particularly the autolysis of yeast cells followed by separation by physical means of the insoluble portion, containing the walls, from the soluble portion.

In the context of the present invention, the deactivated yeasts are considered as being yeasts not having any fermenting power. Any type of deactivated yeast may be used as long as it is of food grade, for example Saccharomyces. They are obtained according to methods known to a person skilled in the art, and more particularly by heat treatments.

According to a most advantageous embodiment of the invention, the deactivated yeasts have a dry matter content greater than 95%.

When a mixture of deactivated yeasts and yeast walls is used, the origin of the yeasts may be identical or different.

The probiotic composition of the invention has a very satisfactory homogeneity.

Without wishing to be bound by any theory, the presence of the yeast walls and/or deactivated yeasts in the composition or premix according to the invention makes it possible to stabilize the probiotic microorganisms by reducing the water content of the probiotic microorganisms and stabilizing this water content over time. This water content greatly increases, on the other hand, when a conventional premix carrier as described in the prior art and comprising in particular wheat meal or calcium carbonate is used. Furthermore, the use of carbonate can cause problems of abrasiveness and segregation.

Thus, according to a particular embodiment, the variation in the dry matter content of the probiotic microorganisms, V_{A}, measured according to the following Test A is positive.

### Test A:

At time T₀, that is to say before mixing the probiotic microorganisms with the yeast walls and/or deactivated yeasts, the dry matter content of the probiotic microorganisms is measured by the ISO 1741 method. A value DM₀ is obtained.

At time T= 14 days, that is to say 14 days after mixing the probiotic microorganisms with the yeast walls and/or deactivated yeasts, the dry matter content of the probiotic microorganisms is measured. A value DM_{T} is obtained.

The following calculation is then performed: V= [(DM_{T}−DM₀)/DM₀]×100.

Preferably, the variation in the dry matter content of the probiotic microorganisms V is greater than 0.5%, preferably greater than 1%.

According to a particular embodiment, the composition or premix according to the invention additionally comprises a nutritional supplement comprising in particular vitamins and/or trace elements and/or amino acids and/or other additives intended for animal feed.

The vitamins entering into the composition are chosen from the group comprising: vitamin A, vitamin D3, vitamin E, vitamins B1, B2, B5, B6, B12, C, PP, biotin, folic acid, choline, vitamin K3, pantothenic acid, and mixtures thereof.

The trace elements entering into the composition may be food grade mineral salts. They are chosen from the group comprising: copper, zinc, iron, manganese, iodine, selenium, and mixtures thereof.

The amino acids entering into the composition are chosen from the group comprising: methionine, lysine, L-threonine, tryptophan, and mixtures thereof.

The probiotic composition or premix described above may be directly incorporated into the animal feedingstuffs. Generally, the composition according to the invention is incorporated into the feedingstuffs in an amount of 5×10⁷ to 5×10¹⁰ CFU (Colony Forming Unit) of probiotic microorganisms per kg of complete feedingstuff, preferably from 5×10⁸ to 1×10¹⁰ CFU per kg of complete feedingstuff.

For example, when the probiotic microorganism of the composition according to the invention is the yeast Saccharomyces cerevisiae Sc47 marketed by the company Lesaffre under the trade mark BIOSAF®, the composition according to the invention will be incorporated into the animal feed so as to have 2.5 to 8*10⁹ CFU of Saccharomyces cerevisiae Sc47 per kg of complete feedingstuff.

The probiotic composition described above may also be used in probiotic granules intended in particular as an animal feed.

Thus, according to another embodiment, the invention relates to probiotic granules which comprise:
the probiotic composition or premix described above, and
a nutritional mixture suitable for the intended animal species.

Generally, the granules of the invention consist of one per thousand by weight of probiotic microorganisms.

The nutritional mixture is a mixture conventionally used by a person skilled in the art for the preparation of granules intended as animal feed, its composition depends on the intended animal species but conventionally comprises vegetable meals such as for example wheat meal and/or soybean oil or rapeseed oil cakes and/or beet pulp and/or molasses and/or urea, in proportions well known to a person skilled in the art. The premix is then incorporated into raw materials (feedingstuffs) the nature and quantities of which depend on the animal species.

This nutritional mixture is optionally enriched with vitamins and/or trace elements and/or amino acids and/or other additives intended for animal feed which are described below in relation to the probiotic composition of the invention.

The granules of the invention are prepared by a method comprising the following steps:
preparation of a probiotic composition or premix according to the invention,
incorporation of said composition or premix into a nutritional mixture suitable for the intended animal species, preferably after a latent period of at least 14 days,
injection of steam at a temperature of between 60° C. and 100° C. under pressures ranging from 0.5 to 3.5 bar into the mixture previously obtained and pressing.

Advantageously, the composition or premix containing the probiotic microorganisms is allowed to stand for at least 15 days, preferably at least 1 month before being incorporated into the nutritional mixture.

The granules obtained according to the method of the invention have a very satisfactory survival rate of the probiotic microorganisms.

According to a particular embodiment, the survival rate of the probiotic microorganisms during granulation may be measured by the ratio S which corresponds to the ratio between the number of CFU after granulation (CFU_{af}) and the number of CFU before granulation (CFU_{be}) multiplied by one hundred. The survival rate of the microorganisms in the granules according to the present invention is such that the value of the ratio S is greater than or equal to 20%, preferably greater than or equal to 50% and more preferably still greater than or equal to 70%.

The invention also relates to a method for improving the stability of probiotic granules comprising the preparation of a probiotic composition or of a premix comprising probiotic microorganisms and yeast walls and/or deactivated yeasts, and optionally a nutritional supplement comprising in particular vitamins, and/or trace elements, and/or amino acids, and/or other additives intended for animal feed, this composition being incorporated into the nutritional mixture before the steam injection granulation step and pressing.

As mentioned above, it was found that the resistance to the granulation temperature lies in particular in increasing or maintaining the dry matter content of the probiotic microorganism present in the composition according to the invention.

The granules of the invention, or obtained according to the method of the invention, are intended to be used as animal feed.

The invention allows a controlled supply of probiotic microorganisms given that the quantity of live probiotic microorganisms in the end in the animal feedingstuff represents at least 20% of the quantity used for the manufacture of the composition according to the invention or of that of the granules.

The present invention will be described and illustrated more precisely in the following examples and figures It is clearly understood that these examples are given solely by way of illustration of the subject of the invention, and do not constitute in any manner a limitation thereto.

### EXAMPLES

### Example 1

### Materials Used

The examples of the present invention are carried out with the following materials:

The probiotic yeasts are those marketed under the trade mark BIOSAF® (in the remainder of the examples only the term BIOSAF® will be used). The product BIOSAF® is a concentrate of live cells of yeasts Saccharomyces cerevisiae strain Sc47, 1×10¹⁰ CFU/g of BIOSAF® (NCYC-47). This product is intended exclusively for animal feed, it is provided in the form of microgranules and exhibits heat stability up to 80° C.

The yeast walls used consist of walls of Saccharomyces cerevisiae and are prepared by autolysis followed by centrifugation.

The deactivated yeasts used consist of Saccharomyces cerevisiae walls and are prepared by heat treatment.

The physical characteristics are given in Table 1 below:

| | | Deactivated | |
|---|---|---|---|
| | Yeast walls | yeasts | BIOSAF ® |
| Particle | Median | Median | Median |
| size | diameter = | diameter = | diameter = |
| | 182.4 μm | 178.4 μm | 1354.2 μm |
| | 68% of the | 68% of the | 68% of the |
| | particles | particles | particles |
| | having a | having a | having a |
| | diameter of | diameter of | diameter of |
| | between 80.6 | between 103.9 | between 992.5 |
| | and 412.8 μm | and 306.4 μm | and 1847.8 μm |
| Apparent | 0.452 | 0.629 | 0.797 |
| density g/cm³ | | | |
| Moisture % | 3.5 | 4.5 | 7.0 |

### Example 2

### 2.1 Preparation of the Premixes

The various mixtures (premixes 1 to 3) whose composition is given in Table 2 below were manually prepared:

| Material | Premix 1 | Premix 2 | Premix 3 | Premix 4 |
|---|---|---|---|---|
| BIOSAF ® | 14% | 14% | 14% | 14% |
| Yeast walls | 14% | 86% | — | — |
| Deactivated | — | — | — | 86% |
| yeasts | | | | |
| Wheat meal | — | — | 14% | — |
| Nutritional | 72% | — | 72% | — |
| supplement | | | | |

The percentages are calculated by weight of the total weight of the premix.

The premix 3 corresponds to a composition entering into the composition of granules of the prior art.

### 2.2—Variation of the Dry Matter Content

The dry matter content of the BIOSAF present in each of the premixes 1 to 3 was measured according to the official ISO 1741 standard at the times T= 1 day, 2 days, 7 days and 14 days. The results obtained are represented in FIG. 1.

The variation of the dry matter content according to Test A is given in the table below:

V=[(DM_{T}−DM₀)/DM₀]×100

contact time

| Premix | 1 Day | 2 Days | 7 Days | 14 Days |
|---|---|---|---|---|
| Premix 1 | +0.1% | +0.5% | +0.6% | +0.7% |
| Premix 2 | +0.4% | +0.5% | +0.8% | +1.2% |
| Premix 3 | −0.9% | −0.9% | −1.0% | −1.2% |

It is important to note that the contact time between BIOSAF® and the other compounds of the premix plays a crucial role since it corresponds to the moisture of the products being brought to equilibrium. If the time factor is unfavorable to a BIOSAF®—wheat meal mixture, it must be a minimum of 14 days in the case of a carrier based on yeast walls and/or deactivated yeasts.

### Example 3

Previous studies have shown that the method of mixing can damage the BIOSAF® product, making it more capable of absorbing ambient moisture. It was therefore essential to manufacture yeast wall-BIOSAF® premixes under industrial conditions in order to confirm the positive effect of said yeast walls.

### 3.1 Preparation of a Premix According to an Industrial Process

The BIOSAF is stored in a silo 5 to 6 meters high. During manufacture, the yeasts are transported over 50 meters to the mixer via a vertical pneumatic conveyor (transfer in dense phase) 10 cm in diameter. An inlet of air (previously treated, dried and cooled) makes it possible to push the product through the conveyor by a succession of plugs of air and plugs of product. At the outlet of the conveyor, a weighing basket checks the weight of the product before entering into the plowshare mixer into which the mixture is simultaneously introduced. The mixer used is a plowshare mixer, its rotating speed is 120 revolutions/min, and the duration of mixing is 60 seconds. The final premix is then directed to a packaging in bags or in bulk.

The composition of the industrially prepared premixes is given in the table below:

| Material | Premix 1a | Premix 3a | Premix 5 |
|---|---|---|---|
| BIOSAF ® | 14% | 14% | 56% |
| Yeast walls | 14% | — | 44% |
| Deactivated yeasts | — | — | — |
| Wheat meal | — | 14% | — |
| Nutritional supplement | 72% | 72% | — |

### 3.2—Variation of the Dry Matter Content

The variation of the dry matter content of BIOSAF® as a function of the time for these various premixes was measured as in Example 2.

In the same way as for the premixes prepared manually, the dry matter content of BIOSAF® decreases in the premix comprising wheat meal (premix 3a): it passes from 93% to 91.7%.

The dry matter content in the premixes according to the invention remains stable in the premix la (14% of yeast walls), but increases by 0.3% after one month of > contact in the premix 5 (44% of yeast walls).

The effect of the yeast walls on the BIOSAF® moisture is less marked when the mixture is prepared under industrial conditions; nevertheless there is no decrease in the dry matter content of BIOSAF® as observed with the conventional premix carriers (based on wheat for example).

### Example 4

### 4.1 Preparation of Granules

Granulation trials were performed on a laboratory press with a fixed flat disk-shaped die (press KAHL.14-175 of 3 kW, having a diameter and a thickness of the channels of 4 and 20 mm respectively (that is a compression ratio of 5)). The packaging machine (INRA, Nantes, France) with 32 rotating blades is 544 mm long and has a 3.75 l volume. The 2.2 kW motor is controlled by a speed regulator which regulates the output. The temperatures are set at the level of the packaging machine (at 80 and 90° C.).

Two batches of granules were prepared under the conditions defined above. A first batch of granules was prepared with a steam injection temperature of 80° C., and a second batch at a steam injection temperature of 90° C.

The premixes were used immediately after their preparation.

The composition of the granules is given below:

| | Granule 1 | Granule 2 |
|---|---|---|
| Wheat | 29.3% | 29.3% |
| Soybean oil cake | 25% | 25% |
| Rapeseed oil cake | 20% | 20% |
| Beet pulp | 20% | 20% |
| Molasses | 3% | 3% |
| Urea | 2% | 2% |
| Premix 3a | 0.7% | — |
| Premix 5 | — | 0.7% |

### 4.2 Study of the Resistance to Granulation

For each of the batches of granules, the BIOSAF® survival rate was measured. The results are given below:

| Granule | 80° C. | 90° C. |
|---|---|---|
| Granule 1 | 9.4% | 2.6% |
| Granule 2 | 23.9% | 5.4% |

### Methods of Calculation:

% resistance or survival rate= quantity of regeneratable cells in the granules (in CFU/g)×100/quantity of regeneratable cells in the granulation composition just before granulation (in CFU/g).

The results show a very low survival rate, demonstrating a very low resistance to granulation of the BIOSAF® incorporated into the premix 3a (granule 1) compared with BIOSAF® batches incorporated into the premix 5 according to the invention (granule 2).

### Example 5

In the same manner as in Example 4, granules were prepared using premixes 3a and 5 whose composition is given in Example 3. However, these premixes were prepared one month before granulation.

| | Granule 1 | Granule 3 |
|---|---|---|
| Wheat | 29.3% | 29.3% |
| Soybean oil cake | 25% | 25% |
| Rapeseed oil cake | 20% | 20% |
| Beet pulp | 20% | 20% |
| Molasses | 3% | 3% |
| Urea | 3% | 2% |
| Premix 3a | 0.7% | — |
| Premix 5 | — | 0.7% |

### 4.2 Study of the Resistance to Granulation

For each of the batches of granules, the resistance to granulation was evaluated by determining the BIOSAF® survival rate. The results are presented below

| Granule | 80° C. |
|---|---|
| Granule 1 | 4.6% |
| Granule 2 | 27.9% |

It is evident therefrom that the granules in accordance with the invention have a resistance to granulation and therefore a survival rate that is six times higher.

1. A probiotic composition or premix comprising:
from 0.5 to 75% of live or regeneratable probiotic microorganisms (a) chosen from the group comprising probiotic yeasts, probiotic bacteria of the type comprising lactic acid bacteria chosen from lactobacilli, and bifidobacteria with the exception of bacilli, and mixtures thereof,
from 10 to 95% of a compound (b) chosen from one or more yeast walls, deactivated yeasts and any combination thereof, and
from 0 to 95% of a nutritional supplement (c) comprising one or more vitamins, trace elements, amino acids, or other additives intended for animal feed and any combination thereof,
the percentages being expressed as dry weight relative to the total weight of the composition.

2. The probiotic composition as claimed in claim 1, preferably comprising:
from 5 to 30% of live or regeneratable microorganisms (a),
from 15 to 80% of one or more yeast walls, deactivated yeasts and any combination thereof (b),
from 5 to 80% of nutritional supplement (c),
the percentages being expressed as dry weight relative to the total weight of the composition.

3. The composition as claimed in claim 1, wherein the probiotic yeasts are chosen from the group comprising yeasts of the genus Saccharomyces, yeasts of the genus Kluyveromyces, and mixtures thereof.

4. The composition as claimed in claim 14, wherein the yeasts correspond to the strains chosen from the group comprising the Saccharomyces cerevisiae Sc47 strain deposited at the NCYC under the number 47, the Saccharomyces cerevisiae strain deposited at the Pasteur collection (CNCM) under the number I-1077, the Saccharomyces cerevisiae strain deposited at the Pasteur collection (CNCM) under the number I-1079, the Saccharomyces cerevisiae strain deposited at the MUCL collection under the number 39 885, the Saccharomyces cerevisiae strain deposited at the CBS collection under the number 39 493.94, the Kluyveromyces marxianus strain deposited at the MUCL collection under the number 39434, and mixtures thereof.

5. The probiotic composition as claimed in claim 1, comprising:
from 0.5 to 75%, of live or regeneratable yeasts,
from 10 to 80%, of one or more yeast walls, deactivated yeasts and any combination thereof,
from 0 to 95% of nutritional supplement,
the percentages being expressed as dry weight relative to the total weight of the composition.

6. The composition as claimed in claim 1, wherein the one or more yeast walls, deactivated yeasts and any combination thereof is chosen from Saccharomyces.

7. The composition as claimed in claim 1, in which the variation of the dry matter content of the probiotic microorganisms measured according to a Test A is positive, according to the Test A, at time T₀, that is to say before mixing the probiotic microorganisms with the one or more yeast walls, deactivated yeasts and any combination thereof, the dry matter content of the probiotic microorganisms is measured by the ISO 1741 method, a value DM₀ is obtained, at time T=14 days, that is to say 14 days after mixing the probiotic microorganisms with the one or more yeast walls, deactivated yeasts and any combination thereof, the dry matter content of the probiotic microorganisms is measured, a value DM_{T} is obtained, the following calculation is then performed: V=[(DM_{T}−DM₀)/DM₀]100.

8. A probiotic granule comprising:
a probiotic composition or premix as claimed in claim 1,
a nutritional mixture suitable for the intended animal feed.

9. The granule as claimed in claim 8, in which the survival rate S of the probiotic microorganisms is greater than or equal to 20%.

10. A method for preparing granules comprising the following steps:
preparation of a probiotic composition or premix as claimed in claim 1,
incorporation of the probiotic composition or premix into a nutritional mixture suitable for the intended animal feed, preferably after a latent period of at least 14 days,
injection of steam at a temperature of between 60° C. and 100° C. at pressures ranging from 0.5 to 3.5 bar into the mixture obtained in the preceding step and pressing.

11. A method for improving the stability of probiotic granules comprising the preparation of a probiotic composition or of a premix as claimed in claim 1, this composition being incorporated into a nutritional mixture suitable for the intended animal species before the steam injection granulation step and pressing.

12-13. (canceled)

14. The composition as claimed in claim 3, wherein the yeasts of the genus Saccharomyces is Saccharomyces cerevisiae and the yeast from the genus Kluyveromyces is Kluyveromyces marxianus.

15. A method for preparing an animal feed composition comprising a step of directly incorporating a probiotic composition or premix into animal feedingstuff, wherein the probiotic composition or premix comprises
from 0.5 to 75% of live or regeneratable probiotic microorganisms (a) chosen from the group comprising probiotic yeasts, probiotic bacteria of the type comprising lactic acid bacteria chosen from lactobacilli, and bifidobacteria with the exception of bacilli, and mixtures thereof,
from 10 to 95% of a compound (b) chosen from one or more yeast walls, deactivated yeasts and any combination thereof, and
from 0 to 95% of a nutritional supplement (c) comprising one or more vitamins, trace elements, amino acids, other additives intended for animal feed and any combination thereof,
the percentages being expressed as dry weight relative to the total weight of the composition.

16. A method for preparing an animal feed composition according to claim 15, wherein the probiotic composition or premix is incorporated into animal feedingstuffs in an amount of 5×10⁷ to 5×10¹⁰ CFU of probiotic microorganisms per kg of complete feedingstuff.

17. A method for preparing an animal feed composition according to claim 16, wherein the probiotic composition or premix is incorporated into animal feedingstuffs in an amount of 5×10⁸ to 1×10¹⁰ CFU of probiotic microorganisms per kg of complete feedingstuff.

18. A method for preparing an animal feed composition comprising a step of directly incorporating at least one probiotic granule into animal feedingstuff, wherein the at least one probiotic granule comprises
a probiotic composition or premix as claimed in claim 1, and
a nutritional mixture suitable for the intended animal feed.

19. A method for preparing an animal feed composition comprising a step of directly incorporating at least one probiotic granule into animal feedingstuff, wherein the at least one probiotic granule is prepared according to the following steps:
preparation of a probiotic composition or premix as claimed in claim 1.
incorporation of the probiotic composition or premix into a nutritional mixture suitable for the intended animal feed, preferably after a latent period of at least 14 days,
injection of steam at a temperature of between 60° C. and 100° C. at pressures ranging from 0.5 to 3.5 bar into the mixture obtained in the preceding step and pressing.

20. Animal feed composition comprising a probiotic composition or premix, wherein the probiotic composition or premix comprises
from 0.5 to 75% of live or regeneratable probiotic microorganisms (a) chosen from the group comprising probiotic yeasts, probiotic bacteria of the type comprising lactic acid bacteria chosen from lactobacilli, and bifidobacteria with the exception of bacilli, and mixtures thereof,
from 10 to 95% of a compound (b) chosen from one or more yeast walls, deactivated yeasts and any combination thereof, and
from 0 to 95% of a nutritional supplement (c) comprising one or more vitamins, trace elements, amino acids, other additives intended for animal feed and any combination thereof,
the percentages being expressed as dry weight relative to the total weight of the composition.

21. Animal feed composition comprising at least one probiotic granule, wherein the at least one probiotic granule comprises
a probiotic composition or premix as claimed in claim 1, and
a nutritional mixture suitable for the intended animal feed.

22. Animal feed composition comprising at least one probiotic granule, wherein the at least one probiotic granule is prepared according to the following steps:
preparation of a probiotic composition or premix as claimed in claim 1,
incorporation of the probiotic composition or premix into a nutritional mixture suitable for the intended animal feed, preferably after a latent period of at least 14 days,
injection of steam at a temperature of between 60° C. and 100° C. at pressures ranging from 0.5 to 3.5 bar into the mixture obtained in the preceding step and pressing.
